(19) United States
(12) Patent Application Publication
(10) Pub. No.: US 2025/0026000 A1
(43) Pub. Date: Jan. 23, 2025

(54) HEATABLE AID WITH ARTICULATED LINKING OF THE LOWER BODY LINKING MEANS

(71) Applicant: J.SCHMALZ GMBH, Glatten (DE)

(72) Inventors: Oliver EBERHARDT, Freudenstadt (DE); Christina HARBAUER-RIESS, Muenchen (DE)

(21) Appl. No.: 18/715,591

(22) PCT Filed: Jun. 1, 2022
(86) PCT No.: PCT/EP2022/064979

§ 371 Date: May 31, 2024

(30) Foreign Application Priority Data
Jan. 5, 2022 (DE) 10 2022 100 203.9

(51) Int. Cl. B25J 9/00

(52) U.S. Cl. CPC B25J 9/0006

(57) ABSTRACT

The invention relates to a wearable aid (10) for supporting in the raising and/or holding of loads by an operator, comprising a supporting structure (16) having a first support (22-1) and a second support (22-2), wherein the first support and the second support each have a rear section (24-1, 24-2) and a cantilever-type section (26-2, 26-2), a lower body linking means (18) for coupling the supporting structure to a pelvic, hip or lumbar area of the operator, an upper body linking means (20) for coupling the supporting structure to an upper body of the operator, a first hand linking means (40-1) and a second hand linking means (40-2), each for linking to a hand or underarm region of the operator, wherein the first support is connected to the lower body linking means via a first lower joint device (48-1) at a first lower connection point (30-1), and wherein the second support (22-2) is connected to the lower body linking means via a second lower joint device (48-2) at a second lower connection point (30-2).

### FIELD

The invention relates to a wearable aid for supporting the raising and/or holding of loads by an operator.

### BACKGROUND

Aids can be used to transfer the loads acting on the user when raising objects either directly to the floor or at least only through selected areas of the body, e.g., an operator's hip area, and thus relieve the user's joint and muscle system.

It is known to design aids as stationary or partially mobile devices which are installed, for example, at a user's workstation. For example, stationary lifting aids such as tube lifters, rope balancers or manipulators are described in the prior art, by means of which unit loads can be picked up and moved from one position to another. However, such aids are limited in their flexibility, as they cannot easily be moved to a new location and made ready for use there.

Aids are also known which are designed as completely mobile devices that can be put on by the user. Such mobile aids usually have one or more body linking means via which the aid can be coupled to the body of an operator and via which forces can be transmitted between the aid and the body.

For example, so-called exoskeletons are known, which can be used as lifting aids for raising loads. Designs are known in which the exoskeleton substantially replicates the entire kinematic chain for the lifting process, i.e., the load-bearing limbs and degrees of freedom of movement of the wearer (“joints” of the exoskeleton) are replicated as accurately as possible by the exoskeleton. Such solutions are also known as anthropomorphic exoskeletons. However, such exoskeletons have the disadvantage that, for reasons of complexity, not all degrees of freedom of the human body are usually represented, resulting in movement restrictions and thus reduced ease of use. In addition, such exoskeletons are often heavy and therefore unwieldy.

WO 2014/195373 A1 also discloses a non-anthropomorphic lifting aid which has support elements that can move relative to one another and multiple body linking means points that are rigidly connected to the support elements.

The known aids are generally only adaptable to the specific anatomical conditions of a user to a limited extent, which can have a negative effect on the transmission of force between the body and the aid. In addition, freedom of movement for the operator and therefore comfort for the user is regularly restricted with the known aids.

### SUMMARY

The invention addresses the problem of providing an aid which effectively relieves a user when handling an object and also enables a high degree of freedom of movement. In addition, the aid should be designed to be ergonomic and comfortable for the user to operate.

This problem is solved by an aid with the features of claim 1. The aid is designed as a wearable aid to support the raising and/or holding of loads by an operator, in the sense of a device that can be worn by a person on the body to support the raising and/or holding of objects (“body-worn lifting aid”). In other words, the aid is designed in particular in such a way that it can be worn by a person and the person can move to another location with the aid worn. In particular, the device can be designed in such a way that it can be put on by the operator like a backpack.

The aid comprises a support structure which is designed to absorb a weight force and/or inertial force of a load and to redirect this force to certain areas of the operator's body.

The support structure comprises a first (right-hand) support and a second (left-hand) support separate from the first support. The first and second supports each have a back section and a cantilever-type section. The supports are designed in such a way that, when the aid is worn by the operator, the back section is arranged posteriorly, i.e., dorsally or “at the rear” of the body, and extends substantially starting from the hip cranially along the back section of the operator or extends starting from the hip cranially along the back section of the operator. This does not mean that the back section must run exactly parallel to the operator's back. The cantilever-type section is designed in such a way that it extends from posterior to anterior, i.e., ventrally or “from the back to the front of the body,” when the aid is worn. When the operator is standing upright, the back section in particular extends substantially vertically and the cantilever-type section at least partially horizontally. In this respect, the back section can form a vertical support and the cantilever-type section can form a horizontal support.

The back section and/or the cantilever-type section can be straight along its longitudinal extent or have a curvature along its longitudinal extent, at least in sections. In particular, the cantilever-type section can be connected to the back section. Preferably, the respective cantilever-type section extends over one shoulder of the operator when the aid is worn. The back section and the cantilever-type section can be formed in one piece or separately from each other. In particular, the back section can be movably connected to the cantilever-type section, for example pivotable about a first and/or second cantilever pivot axis (see below). The back section and the cantilever-type section are particularly dimensionally stable. For example, it is conceivable that the supports are formed from pipe sections and/or cut-to-length profile parts. In order to be able to adapt the aid to different body sizes, in particular back lengths, it can also be advantageous if the back section of a respective support itself is designed to be length-adjustable. It can also be advantageous if the cantilever-type section is designed to be length-adjustable.

The aid also comprises an upper body linking means, in particular a top body linking means, for coupling the support structure to an upper body of the operator. In particular, the upper body linking means can be designed to couple the support structure to a back, shoulder and/or chest area of the operator.

The aid also comprises a lower body linking means, in particular a hip linking means, for coupling the support structure to a pelvic, hip and/or lumbar region of the operator. In particular, the lower body linking means is not designed to couple the support structure to the lower extremities of the operator, such as a thigh, knee or lower leg.

The upper body linking means and the lower body linking means are designed in such a way that forces can be transmitted between the body and the support structure. In particular, the upper body linking means can be designed to introduce forces into the body that result from the dead weight of the support structure, the support reactions required for static equilibrium and/or the guiding forces of the support sections. In particular, the lower body linking means can be designed to transfer the forces and moments resulting from the handling of a load into the body. In particular, the upper and/or the lower body linking means are designed to fix the support structure to an area of the operator's body and thus hold the aid on the operator's body. In this respect, the upper and/or the lower body linking means are designed in particular in such a way that the aid can be “worn” by the operator by coupling the support structure to the body by means of the upper or lower body linking means. The upper and/or lower body linking means can be detachably connected to the support structure, in particular it can be repeatedly connected and disconnected again. Preferably, the upper body linking means and the lower body linking means are arranged at a distance from each other and are force-coupled to each other, in particular exclusively, via the support structure. This has the advantage that no or only a small proportion of the vertical forces resulting directly from a load being held are transferred to the user's upper body.

The aid also comprises a first (right) hand linking means for linking to a right hand or underarm area of the operator, for example to a wrist and/or a carpus of the operator. The first hand linking means is connected to the first support, in particular to a free end of the cantilever-type section of the first support, via a first length-adjustable connecting device.

The aid also comprises a second (left) hand linking means for linking to a left hand or underarm area of the operator, for example a wrist and/or a carpus of the operator. The second hand linking means is connected to the second support, in particular to a free end of the cantilever-type section of the second support, via a second length-adjustable connecting device.

In this respect, the hand linking means serve as a link between the human hand and the aid. The weight and inertia forces of the load being held can be transferred to the support structure via the hand linking means and the connecting devices and then transferred to selected areas of the operator's body via the body linking means. With the proposed aid, the support starts in particular from the wrist of the operator. Preferably, the hand attachments are designed in such a way that the human hand itself is used to grip the object to be lifted, which is superior to technical gripping systems in terms of its versatility. For this purpose, the hand linking means can be designed in various ways. For example, a design as a sleeve that surrounds the carpus and possibly also the wrist of the hand is conceivable.

The length-adjustable connecting devices can be designed in particular as a cable pull. In this respect, the first hand linking means can be connected to the first support via a first cable pull and the second hand linking means can be connected to the second support via a second cable pull. In particular, a common or respective drive device can be provided to drive the cable pulls. In this way, active support for the operator can be achieved, e.g., during a lifting operation or when holding a load statically. In particular, the at least one drive unit can be mounted on the support structure. In particular, the cables of the cable pulls can each be guided via a cable guide, preferably running inside the respective support, and exit the support, in particular the cantilever-type section, via a cable deflection device.

In the proposed aid, the first and second supports are each articulated to the lower body linking means. Specifically, the first support, in particular the back section of the first support, is connected to the lower body linking means at a first lower connection point via a first lower joint device and the second support, in particular the back section of the second support, is connected to the lower body linking means at a second lower connection point via a second lower joint device.

Such an aid makes it possible to effectively relieve an operator when handling objects, but without excessively restricting the operator's freedom of movement. In particular, the articulated connection of the supports to the lower body linking means enables a relative movement of the support structure and the lower body linking means, so that the support structure can follow the body movement of the operator at least to a certain extent. For example, it is conceivable that the operator can bend their upper body forwards or tilt it to the side even when the aid is on, which is particularly advantageous for picking up or placing objects. In this respect, the operator can carry out a work activity with largely “natural” movement patterns despite the aid being worn.

Increased freedom of movement is achieved in particular if the first lower joint device and the second lower joint device each have at least two, in particular three, degrees of joint freedom. In this respect, the lower joint devices are designed in particular in such a way that the supports can be moved along at least two degrees of freedom relative to the lower body linking means.

In an advantageous embodiment, the first lower joint device and the second lower joint device can each be designed in such a way that, when the aid is worn by an operator, an angle of inclination of the respective support relative to the median plane and/or an angle of inclination of the respective support relative to the frontal plane can be changed, in particular adjusted. In the present context, the median plane—as is common in anatomy—refers to a body plane, particularly a vertical one, which extends from the front body wall to the rear body wall and divides the body symmetrically into a right and a left half. In the following context, the frontal plane—as is common in anatomy—refers to a body plane, particularly a vertical one, which divides the body into a front and a rear part. Such a design enables the operator to perform body movements that are as natural as possible during a work process, for example bending the upper body, tilting it to the side and/or twisting it relative to the hips. In addition, a balancing movement to the hip can be realized in this way, especially when walking. Preferably, the first and second lower joint devices can be adjusted independently of each other.

In order to be able to carry out the above-mentioned body movements with as little interference as possible, it can also be advantageous if the first lower joint device and the second lower joint device are each designed in such a way that the respective support can be pivoted, in particular rotated, about its longitudinal axis. In particular, the first and second supports are pivotably, especially rotatably, mounted at the respective lower connection points on the lower body linking means.

A particularly advantageous embodiment is that the first support and the second support are each connected to the lower body linking means via a ball joint. In this respect, the first lower joint device and the second lower joint device can each comprise a ball joint, in particular consist of a ball joint.

For efficient application of force and a high level of comfort, it can also be advantageous if the aid can be variably adapted to the body dimensions of an operator. For this purpose, the lower body linking means can in particular be designed in such a way that a relative position of the first lower connection point and the second lower connection point, in particular of the first lower joint device and the second lower joint device, can be changed, in particular adjusted. It can be particularly advantageous if the lower body linking means is designed in such a way that a position of the first lower connection point and/or the second lower connection point can be changed laterally and/or medially relative to the median plane, i.e., in particular orthogonally to the median plane, when the aid is worn by the operator. This makes it possible to adapt the lower body linking means to a hip width and/or a corresponding curvature of the operator's hips, thus achieving both a high level of wearing comfort and an efficient transfer of forces to the operator's hip area.

Furthermore, it can be advantageous if the lower body linking means is designed such that, when the aid is worn by the operator, a position of the first lower connection point and/or the second lower connection point can be changed, in particular adjusted, in the anterior direction and/or in the posterior direction relative to the frontal plane, in particular orthogonally to the frontal plane. This makes it possible to adjust a dorsal distance of the first and/or second lower connection point to the frontal plane, i.e., in particular a distance of the first and/or second lower connection point to the back of the operator, and in this way to adapt the aid to the specific shape of the operator's back.

In an advantageous embodiment, the lower body linking means can comprise a lower force distribution device, which is connected to the supports, in particular to the back sections of the supports. In addition, the lower body linking means can comprise a body linking means device connected to the lower force distribution device via one or more force application points or force application surfaces for linking to an area of the operator's body, in particular to a hip, pelvic and/or lumbar area of the operator. The lower force distribution device is designed in particular to absorb forces from the supports and redirect them to the lower body linking means device, which then transfers the forces to the operator's body, in particular over a large area and avoiding pressure peaks.

In particular, the lower body linking means device can be designed to be flexible so that the body linking means device can be variably adapted to the anatomy of the operator. For this purpose, the lower body linking means device can comprise, in particular consist of, at least one textile part. The at least one textile part can be in the form of a belt or a cuff, for example. For example, it is conceivable that the lower body linking means device comprises one or more straps that surround the pelvis and/or hips of the operator and are equipped with corresponding buckle elements that allow flexible adjustment to the height of the operator. Such a design offers a high level of wearing comfort and at the same time favors reliable attachment of the aid to the operator's body, which enables efficient application of force in the hip area.

In an advantageous embodiment, the lower force distribution device can have a lower main body which extends between the first support and the second support, in particular between the back section of the first support and the back section of the second support. In an advantageous way, the lower joint devices are arranged on the main body. In this respect, the main body serves as a lower connecting link between the first and second support. However, the main body can also be constructed in multiple parts.

Preferably, the lower body linking means, in particular the lower main body, comprises a first lower adjustment mechanism, which is designed to change, in particular adjust, a distance between the lower connection points, in particular the lower joint devices. In particular, the first lower adjustment mechanism can be designed to change a position of the lower connection points laterally and/or medially relative to the median plane when the aid is worn. For example, it is conceivable that the supports are each mounted on a rack, which is laterally and medially displaceably mounted on the main body via a rack and pinion mechanism.

Furthermore, it can be advantageous if the lower body linking means comprises a second lower adjustment mechanism which is designed to change a position of the lower connection points in the anterior direction and/or in the posterior direction relative to the frontal plane. For example, it is conceivable that the first and second supports, in particular the first and second lower joint devices, are each mounted on the main body so that they can pivot about a pivot axis. In particular, the pivot axis is oriented orthogonally to the transverse plane when the aid is worn and the body is in an upright position. In the following context, the transverse plane—as is common in anatomy—refers to a plane that runs transversely, i.e., orthogonally to the longitudinal axis of the operator, in particular horizontally, through the body and thus divides the operator's body into an upper and a lower part. In this respect, the pivoting device can be designed in particular to change a position of the lower joint devices in the anterior or posterior direction relative to the frontal plane. For example, the lower joint devices can each be mounted in a rotationally fixed manner on a pivoting wing, which in turn is mounted, in particular supported, on the lower main body so that it can pivot about the pivot axis. The first and/or the second lower adjustment mechanism can preferably be actuated via an operating element in such a way that the operator can independently set a position of the connection points when the aid is worn and change it if necessary.

In an advantageous embodiment, the lower force distribution device can comprise a first, in particular anatomically shaped, hip shell for contact with a right hip area of the operator and a second, in particular anatomically shaped, hip shell for contact with a left hip area of the operator. The hip shells are held in particular on the flexible body linking means device, preferably on the at least one textile part, and are force-coupled to each other via this. In particular, the first support is connected to the first hip shell via the first lower joint device and the second support is connected to the second hip shell via the second lower joint device. In this respect, the hip shells are designed in particular to absorb handling forces from the supports and transfer them to the hip area of the operator, in particular over a large area and avoiding pressure peaks. Such a design of the lower force distribution device with hip shells enables a particularly effective application of force to the body and is also characterized by a high level of comfort.

For efficient force transmission, it can also be advantageous if the hip shells are designed in such a way that, when the aid is worn by the operator, the hip shells protrude into a groin area of the operator in such a way that forces directed dorsally, i.e., in the direction of the back, into the body, in particular horizontal forces, can be transmitted into the operator's body via the hip shells.

In order to be able to individually adapt the lower body linking means to a specific physique of the operator, it can also be advantageous if the first and second hip shells are displaceably mounted on the flexible body linking means device, in particular the at least one textile part, in particular along the hip contour. In particular, the hip shells can be held on the flexible body linking means device in such a way that by displacing the first and/or the second hip shell relative to the flexible body linking means device, a distance between the lower connection points and thus a distance between the supports relative to each other can be changed, in particular adjusted. In particular, the hip shells can be displaceably mounted on the lower body linking means device in such a way that, by displacing the hip shells, a position of the lower connection points laterally or medially relative to the median plane and/or in the anterior or posterior direction relative to the frontal plane can be changed, in particular adjusted.

In an advantageous further development, the lower force distribution device can additionally comprise at least one lumbar support. The at least one lumbar support can then be mounted in particular on the lower body linking means device, in particular the at least one textile part, and force-coupled to the first and second hip shell via this. This allows handling forces to be distributed to additional areas of the body. In addition to force transmission via the lower body linking means device, the at least one lumbar support can be connected to the hip shells via at least one elastic element, in particular an elastic band, which is tensioned between the lumbar support and the hip shells. Depending on the stiffness of the at least one elastic element, the percentage of force introduced into the lumbar support can be adjusted.

It is conceivable that the support structure is only coupled to the upper body linking means via one of the two supports. For efficient force transmission, however, it is advantageous if the first support is connected to the upper body linking means at a first upper connection point and if the second support is connected to the upper body linking means at a second upper connection point. In an advantageous further development, the first support and the second support can be articulated to the upper body linking means. In particular, the first support can be connected to the upper body linking means at the first upper connection point via a first upper joint device and the second support can be connected to the upper body linking means at the second upper connection point via a second upper joint device. Such a design further increases the operator's freedom of movement and also improves the wearing comfort of the aid.

It is particularly advantageous if the first upper joint device and the second upper joint device each have at least two, preferably at least three, degrees of articulation freedom, i.e., are designed in particular in such a way that the supports can be moved along at least two, preferably at least three, degrees of freedom relative to the upper body linking means.

In particular, the upper joint devices can each have a first degree of freedom of pivoting about a first pivot axis. When the aid is worn, the first pivot axis is in particular oriented orthogonally to the median plane. This degree of freedom of pivoting allows the operator to bend their torso and at the same time helps to compensate for asymmetrical body movements. In addition, the first degree of freedom of pivoting favors a trouble-free rotation of the upper body relative to the hip, especially in combination with the degrees of joint freedom of the lower joint devices described above. The first degree of freedom of pivoting can be provided in particular by a first pivot joint, which is connected to the upper body linking means, in particular an upper main body of the body linking means.

The upper joint devices can also each comprise a second degree of pivoting freedom about a second pivot axis orthogonal to the first pivot axis. When the aid is worn, the second pivot axis is then in particular oriented orthogonally to the frontal plane. The second degree of freedom of pivoting also makes it possible to simulate asymmetrical body movements, such as those that occur when lifting and/or carrying with just one hand. In addition, the second degree of freedom of pivoting favors a trouble-free lateral tilt and/or rotation of the upper body relative to the hip, especially in combination with the degrees of joint freedom of the lower joint devices described above. The second degree of freedom of pivoting can be provided in particular by a second pivot joint, which is connected to the first pivot joint.

The upper joint devices can also each comprise a translational degree of freedom, in particular along a longitudinal axis of the respective support, further in particular along a longitudinal axis of the back section of the respective support. In this respect, the upper joint devices can be designed in particular in such a way that the supports are mounted on the upper body linking means so that they can be moved axially along their longitudinal axis. The translational degree of freedom means that the upper and lower body linking means in particular can be decoupled from each other, thus preventing vertical forces resulting from lifted loads from being transferred to the upper body, especially the operator's shoulders. In addition, the translational degree of freedom can be used to simulate opposing hip movements when walking and/or back extension during trunk flexion in the aid.

The translational degree of freedom can be provided in particular by a sliding sleeve in which the respective support, in particular with its back section, is axially displaceable along the longitudinal axis of the support. It is also conceivable that the translational degree of freedom is formed in the respective support itself, in particular in the back section.

In particular, the sliding sleeve can be designed in such a way that the support is mounted in the sliding sleeve so that it can pivot about its longitudinal axis, i.e., about the sliding axis. Such a design increases the user's freedom of movement, especially when the hips and chest twist against each other when walking or during a back rotation. In addition, such a configuration makes it possible, for example, to move the arms to the left and right even when the arms are extended anteriorly parallel to the median plane. Such a body movement is particularly favored in combination with the degrees of joint freedom of the lower joint devices. Preferably, the respective sliding sleeve is designed in such a way that a maximum pivot angle is limited in such a way that the extension arm section cannot be pivoted against a body area, in particular against the head, of the operator.

In an advantageous embodiment, the upper body linking means can comprise an upper force distribution device, which is connected to the supports, in particular to the back section of the supports, via the upper joint devices. The upper body linking means can also comprise a flexible upper body linking means device connected to the upper force distribution device, in particular one that can be adapted to the anatomy of the operator, for linking to an upper body area of the operator. The upper force distribution device is designed in particular to absorb forces from the supports and redirect them to the upper body linking means device, which then transfers the forces to the operator's body.

The upper body linking means device can in particular comprise, in particular consist of, at least one textile part. The at least one textile wedge can be in the form of a belt or a cuff, for example. It is conceivable, for example, that the upper body linking means device comprises a belt system. In particular, the belt system can be designed in such a way that the aid can be put on by the operator like a backpack.

A particularly stable design can be that the upper force distribution device has an upper main body which extends between the first support and the second support, in particular between the back section of the first support and the back section of the second support. The upper joint devices can then be arranged on the upper main body. In this respect, the upper main body serves as the upper connecting link between the first and second support. However, the upper main body can also be constructed in one or more parts.

As part of an advantageous further development, the upper force distribution device can also comprise a force introduction plate to support the introduction of horizontal forces into a back area of the operator. In particular, the force introduction plate is arranged on the upper body linking means in such a way that the force introduction plate is aligned parallel to a back surface of the operator, in particular in the middle of the back, when the aid is worn. Preferably, the force introduction plate is connected to the upper main body in such a way that a distance between the force introduction plate and the upper main body and thus a distance between the main body and the back can be changed, in particular adjusted. The force introduction plate is also preferably connected to the upper body linking means device, for example the belt system described above, in such a way that a position of the force introduction plate can be changed, in particular adjusted, cranially, i.e., in the direction of the head of the operator, or caudally, i.e., in the direction of the buttocks of the operator. For example, it is conceivable that the position of the force introduction plate can be changed cranially or caudally by changing the length of the belt system described above. Such a design makes it possible to flexibly adapt the position of the force introduction plate to the anatomical conditions of the operator and thus achieve an efficient application of force to the body.

In order to be able to flexibly adapt the upper body linking means to the shape of the operator's back, it can also be advantageous if the upper body linking means is designed in such a way that a relative position of the first upper connection point and the second upper connection point can be changed, in particular adjusted. In particular, the upper body linking means can be designed in such a way that, when the aid is worn by the operator, a position of the first upper connection point and/or the second upper connection point can be changed, in particular can be adjusted, laterally and/or medially relative to the median plane. Such a design makes it possible to adjust the upper body linking means to a back width and thus to set an optimum fit of the aid for the operator. The upper body linking means can also be designed in such a way that, when the aid is worn by the operator, a position of the first upper connection point and/or the second upper connection point can be changed, in particular adjusted, in the anterior direction and/or in the posterior direction relative to the frontal plane. This makes it possible to set a distance between the supports and the operator's back. In combination with the articulated connection of the supports to the lower body linking means, the adjustment options of the upper body linking means described above can be used in particular to achieve an inclination of the supports relative to the median plane and the frontal plane.

It can be particularly advantageous if the upper and lower body linking means are designed in such a way that a relative position of the upper connection points and a relative position of the lower connection points can be changed, in particular can be adjusted, independently of one another. Such a design makes it possible to depict combinations of different anatomies, e.g., broad shoulders in combination with narrow hips. This is facilitated in particular by combining the adjustability of the upper and/or lower body linking means with the articulated connection of the supports to the lower and/or upper body linking means.

In an advantageous embodiment, the upper body linking means can have a first upper adjustment mechanism, which is designed to change a position of the first and/or the second upper connection point laterally and/or medially relative to the median plane when the aid is worn and thus to adjust a distance between the supports. In order to be able to adjust the position of the first and second upper connection points independently of one another, it can be advantageous if the first and second supports are each assigned a first upper adjustment mechanism which is designed to displace the upper connection point of the respective support laterally and medially relative to the median plane when the aid is worn. For example, it is conceivable that the supports are each mounted on a rack, which is laterally and medially displaceably mounted on the upper body linking means, in particular a main body of the upper body linking means, via a rack and pinion mechanism.

Alternatively or additionally, the upper body linking means can have a second upper adjustment mechanism, which is designed to change a position of the first and/or the second upper connection point in the anterior (ventral) and/or posterior (dorsal) direction relative to the frontal plane when the aid is worn and thus in particular to adjust a distance between the supports and the operator's back. It is particularly advantageous if the first and second supports are each assigned a second upper adjustment mechanism which is designed to displace the upper connection point of the respective support in the anterior (ventral) and posterior (dorsal) directions relative to the frontal plane when the aid is worn. In this respect, each support can be assigned its own first upper adjustment mechanism and/or a second upper adjustment mechanism.

The second upper adjustment mechanism can in particular comprise three segments that are adjustable relative to one another, wherein a first segment is connected to the upper force distribution device, in particular the upper main body, and wherein a second segment is connected to the respective support, in particular via the upper joint device. A third segment is then arranged in particular between the first and second segments and is pivotably connected to the first segment and pivotably connected to the second segment. Preferably, the second upper adjustment mechanism is designed in such a way that the first segment and the second segment are always aligned parallel to each other. Such a design makes it possible to easily adjust the distance between the upper connection points and the back.

In an advantageous embodiment, the cantilever-type section of the first support can be pivotably connected to the back section of the first support and the cantilever-type section of the second support can be pivotably connected to the back section of the second support. Preferably, the respective cantilever-type section is arranged on the respective back section so that it can pivot about a first, in particular vertical, cantilever pivot axis parallel to the longitudinal axis of the back section. This makes it possible to swivel the cantilever-type section to the left or right when the aid is worn, in particular without having to swivel the back section as well. Alternatively or additionally, the respective cantilever-type section can be arranged on the back section so as to be pivotable about a second cantilever pivot axis that is orthogonal, in particular horizontal, to the longitudinal axis of the back section and to a longitudinal axis of the cantilever-type section. This makes it possible to swivel the cantilever-type section “upwards” or “downwards,” in particular without having to swivel the back section as well.

In order to prevent undesired adjustment of the aid after successful adaptation to the anatomy of the operator, for example during a work process, it can also be advantageous if the aid comprises a fixing device for fixing a relative position of the first and second lower connection points and/or a fixing device for fixing a relative position of the first and second upper connection points.

It can also be advantageous for wearing the aid if the degrees of freedom of articulation of the upper joint devices and/or the degrees of freedom of articulation of the optional lower joint devices can be locked and thus the supports can be fixed in a predetermined latching position. For this purpose, the aid can comprise a fixing device for fixing the first and second lower joint devices and/or a fixing device for fixing the first and second upper joint devices.

### BRIEF DESCRIPTIONS OF THE DRAWINGS

The invention is explained in more detail below with reference to the figures. In the drawings:

FIG. 1 shows a simplified schematic representation of an embodiment of an aid;

FIG. 2 shows a simplified schematic representation to explain a state of use of the aid;

FIG. 3 shows a simplified schematic representation of a lower body linking means of the aid in a front view;

FIG. 4 shows a simplified schematic representation of an assembly of the lower body linking means according to FIG. 3 in a perspective rear view;

FIG. 5 shows a simplified schematic representation of the aid in a side view;

FIG. 6 shows a sketched representation of an embodiment of the lower body linking means in a perspective rear view;

FIG. 7a-c show sketched representations of a further embodiment of the lower body linking means in various views;

FIG. 8 shows a sketched representation of the lower body linking means according to FIG. 7a-c in a plan view;

FIG. 9 shows a simplified schematic representation of an upper body linking means of the aid in a plan view;

FIG. 10 shows a simplified schematic representation of a body linking means device of the upper body linking means;

FIG. 11 shows a simplified schematic representation of an embodiment of the upper body linking means in a front view;

FIG. 12 shows a sketched representation of an embodiment of the upper body linking means in a rear view; and

FIG. 13 shows a simplified schematic representation of the aid to explain the adjustability.

In the following description and in the figures, identical reference signs are in each case used for identical or corresponding features.

### DETAILED DESCRIPTION

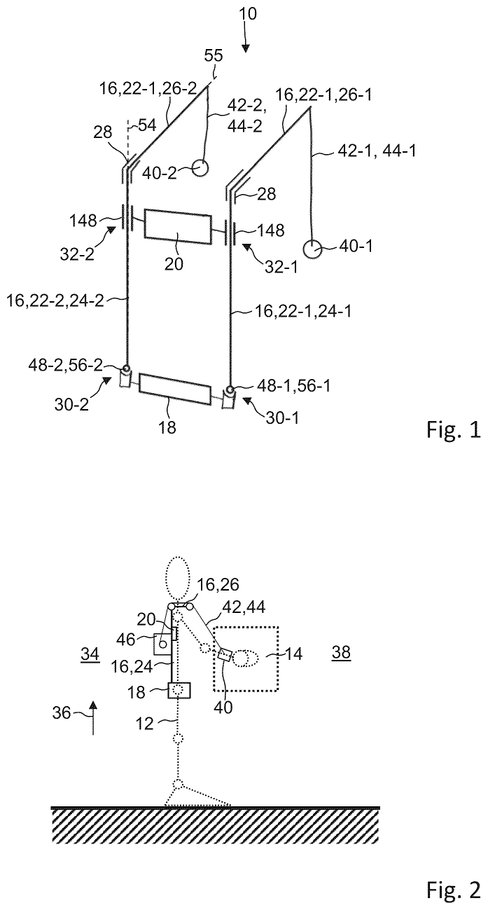

FIG. 1 shows, in a simplified schematic representation, a wearable aid, which is denoted as a whole by reference sign 10. The aid 10 is designed to support an operator 12 when raising and/or carrying a load 14 (cf. FIG. 2). As explained in detail below, the aid 10 is designed as a mobile device that can be worn and transported by the operator 12.

The aid 10 comprises a support structure 16, which is designed to absorb a load-bearing force, in particular the weight force and/or inertial force of a load 14 held by the operator 12, and to divert it to certain areas of the body of the operator 12. For this purpose, the aid 10 also comprises a lower body linking means 18 for coupling the support structure 16 to a pelvic, hip and/or lumbar region of the operator 12 and an upper body linking means 20 for coupling the support structure 16 to an upper body of the operator 12 (cf. FIGS. 1 and 2).

The support structure 16 comprises a first (right) support 22-1 and a second (left) support 22-2. As can be seen from FIG. 1, the supports 22-1, 22-2 each comprise a back section 24-1, 24-2 and a cantilever-type section 26-1, 26-2. In the example shown, the back sections 24-1, 24-2 are connected to the cantilever-type sections 26-1, 26-2 via only schematically indicated support connectors 28. It is also conceivable that the back sections 24-1, 24-2 are formed in one piece with the corresponding cantilever-type sections 26-1, 26-2. It is also conceivable that the cantilever-type sections 26-1, 26-2 are pivotably connected to the corresponding back sections 24-1, 24-2 via corresponding cantilever joints (not shown). For example, the cantilever joint can be designed in each case in such a way that the respective cantilever-type section 26-1, 26-2 can be pivoted about a first, in particular vertical, cantilever pivot axis parallel to the longitudinal axis 54 of the back section 24-1, 24-2 and/or can be pivoted about a second, in particular horizontal, cantilever pivot axis orthogonal to the longitudinal axis 54 of the back section 24-1, 24-2 and to a longitudinal axis 55 of the cantilever-type section 26-1, 26-2.

As shown schematically in FIG. 1, the first support 22-1 is connected to the lower body linking means 18 at a first lower connection point 30-1 and is connected to the upper body linking means 20 at a first upper connection point 32-1. Accordingly, the second support 22-2 is connected to the lower body linking means 18 at a second lower connection point 30-2 and is connected to the upper body linking means 20 at a second upper connection point 32-2 (explained in more detail below).

As can be seen from FIG. 2, the aid 10 is designed in such a way that when the aid 10 is worn by the operator 12, the back sections 24-1, 24-2 are arranged posteriorly, i.e., on a rear side 34 of the operator 12, and extend cranially (cf. arrow 36 in FIG. 2) from the lower body linking means 18 along the back section of the operator 12 (in FIG. 2 by way of example vertically). The cantilever-type sections 26-1, 26-2 are designed such that they extend from posterior to anterior, i.e., from the rear side 34 to a front side 38 of the operator 12, in particular over a shoulder of the operator, when the aid 10 is worn.

In the example shown, the back sections 24-1, 24-2 and the cantilever-type sections 26-1, 26-2 are orthogonal to each other. However, other embodiments are also conceivable in embodiments not shown. For example, it is conceivable that the respective cantilever-type section 26-1, 26-2 adjoins the back section 24-1, 24-2 and has a curvature such that the cantilever-type section 26-1, 26-2 extends anteriorly to posteriorly when the aid 10 is worn.

The aid 10 further comprises a first hand linking means 40-1 for linking to a right hand or underarm area of the operator 12 and a second hand linking means 40-2 for linking to a left hand or underarm area of the operator 12. As shown schematically in FIG. 1, the first hand linking means 40-1 is connected to the cantilever-type section 26-1 of the first support 22-1 via a first, in particular length-adjustable, connecting device 42-1. The second hand linking means 40-2 is connected to the cantilever-type section 26-2 of the second support 22-2 via a second, in particular length-adjustable, connecting device 42-2. By way of example and preference, the connecting device 42-1, 42-2 can be a driven cable pull 44-1, 44-2. The aid 10 can then also have a common drive device or a separate drive device 46 for each cable pull 44-1, 44-2, which is preferably mounted on the support structure 16 (cf. FIG. 2). The aid 10 can then comprise a cable guide (not shown) for each cable pull 44-1, 44-2, in particular integrated in the supports 22, which is designed to guide the cable from the drive device 46 to the hand linking means 40-1, 40-2. In particular, the cable can then exit at a free end of the cantilever-type section 26-1, 26-2 via a cable deflection device (not shown).

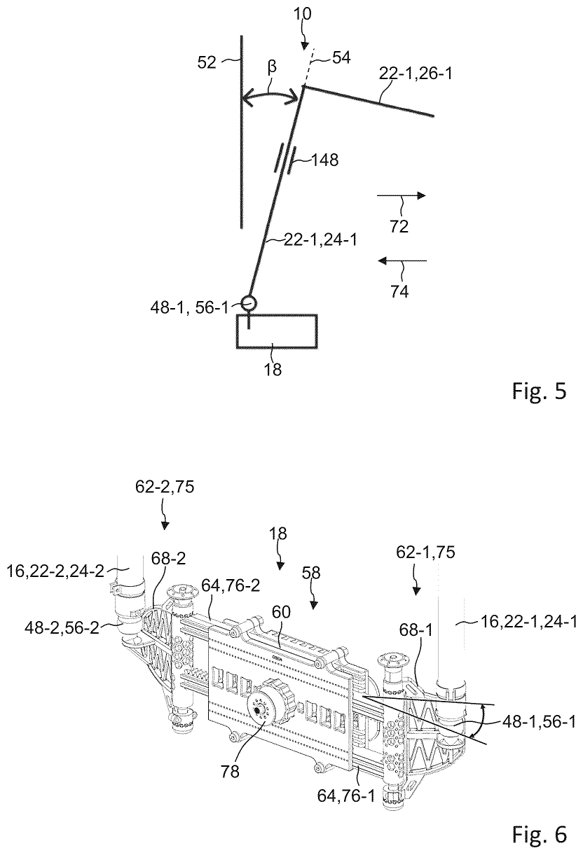

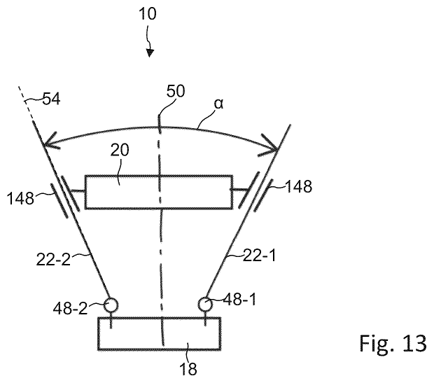

As shown schematically in FIG. 1, the first support 22-1 is connected to the lower body linking means 18 at the first lower connection point 30-1 via a first lower joint device 48-1 and the second support 22-2 is connected to the lower body linking means 18 at the second lower connection point 30-2 via a second lower joint device 48-2. The lower joint devices 48-1, 48-2 are each designed in such a way that, when the aid 10 is worn, an angle of inclination α of the respective support 22-1, 22-2 relative to the median plane 50 (cf. FIG. 13) and an angle of inclination β of the respective support 22-1, 22-2 relative to the frontal plane 52 (cf. FIG. 5) can be changed. In addition, the lower joint devices 48-1, 48-2 are designed such that the respective back section 24-1, 24-2 of the respective support 22-1, 22-2 is mounted on the lower body linking means 18 such that it can pivot about its longitudinal axis 54. In the example shown, the lower joint devices 48-1, 48-2 are designed as ball joints 56-1, 56-2.

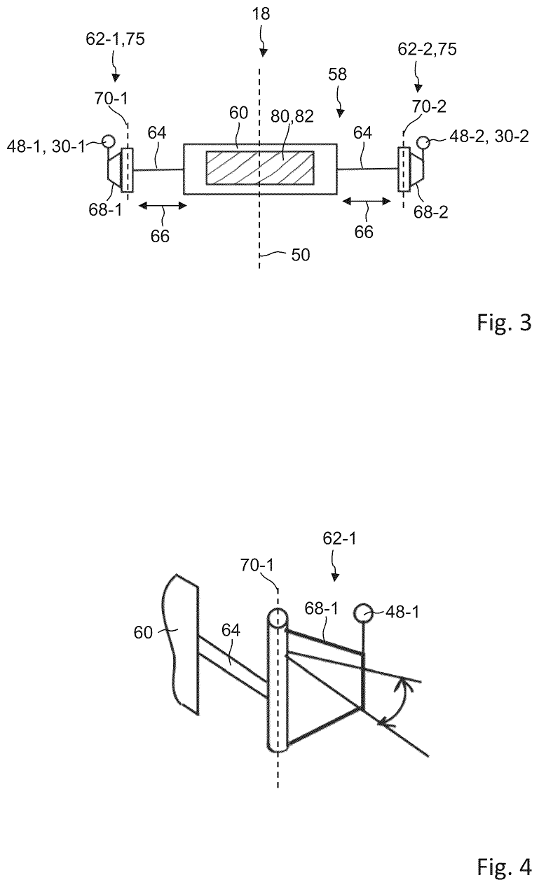

FIG. 3 shows a simplified schematic representation of an embodiment of the lower body linking means 18. As can be seen from FIG. 3, the lower body linking means 18 comprises a main body 60, which is arranged between the back sections 24-1, 24-2. As shown in FIG. 4, the supports 22-1, 22-2 are held on the main body 60 via the lower joint devices 48-1, 48-2, for example via a pivoting device 62 described in detail below. The main body 60 is part of a lower force distribution device 58, which is designed to absorb forces from the supports 22-1, 22-2 and to transfer them over a large area into the body linking means 18.

The main body 60 comprises a first lower adjustment mechanism 64, which is designed to change, in particular to adjust, a distance between the lower joint devices 48-1, 48-2 and the main body 60 and thus a distance between the supports 22-1, 22-2 (shown in FIG. 3 by the double arrows 66). When the aid 10 is worn, a position of the first lower connection point 30-1 and the second lower connection point 30-2 orthogonal to the median plane 50, i.e., medially or laterally, can be changed, in particular adjusted.

In the example shown, the lower joint devices 48-1, 48-2 are each held on the lower main body 60 via a pivoting device 62-1, 62-2 already mentioned above. As shown in FIG. 4 by way of example, the lower joint devices 48-1, 48-2 are each mounted on a pivoting wing 68-1, 68-2, which is mounted on the lower main body 60 so as to be pivotable about a pivot axis 70-1, 70-2. When the aid 10 is worn, the pivot axis 70-1, 70-2 is in particular oriented orthogonally to the transverse plane (in the upright body position). The pivoting devices 62-1, 62-2 thus make it possible to change a position of the lower connection points 30-1, 30-2 in the anterior direction (ventrally, cf. arrow 72 in FIG. 5) or in the posterior direction (dorsally, cf. arrow 74 in FIG. 5) relative to the frontal plane 52. In this respect, the pivoting devices 62-1, 62-2 form a second lower adjustment mechanism 75.

An exemplary embodiment of the lower body linking means 18 with first and second lower adjustment mechanisms 64, 75 is shown in FIG. 6. As can be seen from FIG. 6, the first adjustment mechanism 64 comprises, by way of example, a left and a right rack and pinion device 76-1, 76-2 via which the pivoting devices 62-1, 62-2 connected to the lower joint devices 48-1, 48-2 are displaceably held on the main body 60. Preferably, the rack and pinion devices 76-1, 76-2 can be actuated via a lower operating unit 78.

As indicated only in sections in FIG. 3, the lower body linking means 18 also comprises a flexible lower body linking means device 80 for attachment to a hip, pelvic and/or lumbar region of the operator 12. The lower body linking means device 80 comprises in particular a textile part 82, via which the aid 10 is connected to the body. For example, the textile part 82 may be in the form of a waist belt (not shown), which comprises a hip area of the operator 12.

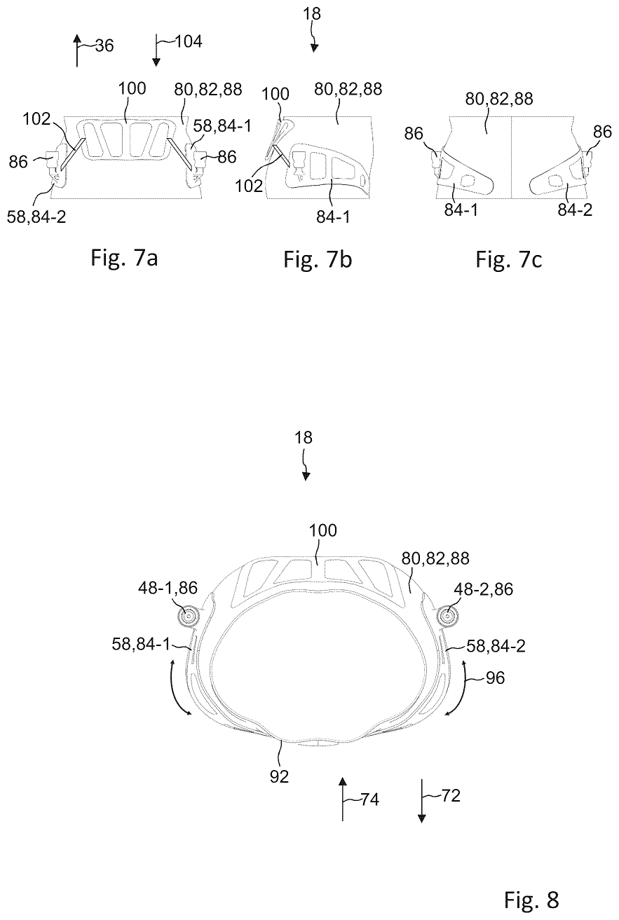

FIGS. 7a to 8 show a further exemplary embodiment of the lower body linking means 18. As can be seen from FIG. 7c, the lower force distribution device 58 in this embodiment is formed by two, preferably anatomically shaped, hip shells 84-1, 84-2. The lower joint devices 48-1, 48-2 are mounted on the hip shells 84-1, 84-2. By way of example, a respective ball mount 86 of the ball joints 56-1, 56-2 is held on the hip shells 84-1, 84-2. The hip shells 84-1, 84-2 are arranged on a textile part 82, which forms the lower body linking means device 80. The textile part 82 can be designed as a belt or waistband 88, for example. As can be seen from FIGS. 7c and 8, the hip shells 84-1, 84-2 are exemplarily and preferably designed and held on the textile part 82 in such a way that the hip shells 84-1, 84-2 project ventrally (cf. arrow 72 in FIG. 8) into a groin region 92 of the operator 12 when the aid 10 is worn in such a way that forces directed dorsally (cf. arrow 74 in FIG. 7) can be introduced into the body of the operator 12 via the hip shells 84-1, 84-2. The hip shells 84-1, 84-2 are preferably displaceably held on the textile part 82 in such a way that by displacing the hip shells 84-1, 84-2 relative to the textile part 82, a position of the lower connecting points 30-1, 30-2 can be changed, in particular adjusted, both laterally or medially relative to the median plane 50 and anteriorly or posteriorly relative to the frontal plane 52 (indicated in FIG. 8 by the double arrow 96).

In the example shown, the lower body linking means 18 also comprises an optional lumbar support 100, which is part of the lower force distribution device 58. The lumbar support 100 is mounted on the textile part 82 and is force-coupled via this to the hip shells 84-1, 84-2. Optionally, the lumbar support 100 can also be connected to the hip shells 84-1, 84-2 via one or more elastic straps 102 (cf. FIG. 7a). The lumbar support 100 is mounted on the textile part 82 in an exemplarily and preferably displaceable manner such that a position of the lumbar support 100 can be changed, in particular adjusted, cranially (cf. arrow 36 in FIG. 7a) or caudally (cf. arrow 104 in FIG. 7a).

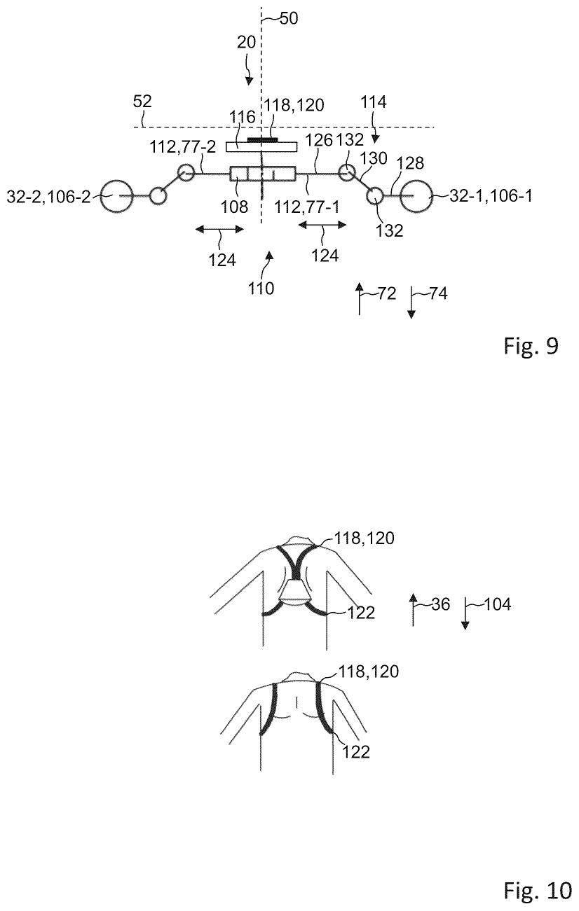

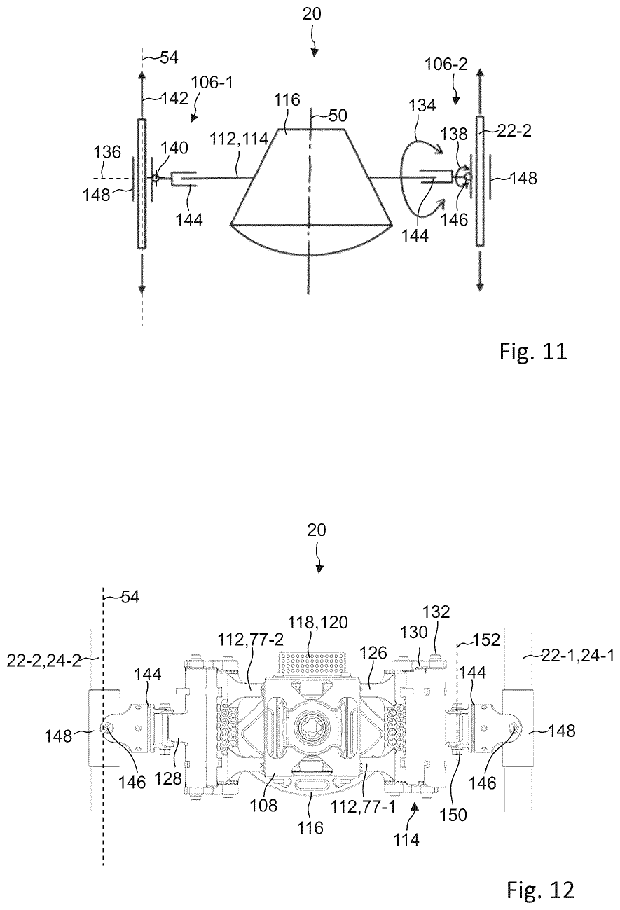

FIG. 9 shows a simplified schematic representation of an exemplary design of the upper body linking means 20 in a plan view. As shown only schematically in FIG. 9, the first support 22-1 is optionally connected to the upper body linking means 20 at the first upper connection point 32-1 via a first upper joint device 106-1 and the second support 22-2 is optionally connected to the upper body linking means 20 at the second upper connection point 32-2 via a second upper joint device 106-2 (described in more detail below with reference to FIG. 11).

In the example shown, the upper body linking means 20 comprises an upper main body 108 which is arranged between the back sections 24-1, 24-2. The main body 108 is part of an upper force distribution device 110, which is designed to absorb and redirect forces from the supports 22-1, 22-2. The upper joint devices 106-1, 106-2 are each connected to the upper main body 108 via a first and a second adjustment mechanism 112, 114 (described in detail below).

The upper body linking means 20 also comprises a force introduction plate 116, which is also part of the upper force distribution device 110. For example and preferably, the force introduction plate 116 is displaceably mounted on the upper main body 108 in such a way that a distance between the upper main body 108 and the force introduction plate 116 and thus a distance between the upper main body 108 and the back can be changed, in particular adjusted.

As shown in FIG. 10 as an example, the force introduction plate 116 is connected to a belt system 118, via which the aid 10 can be connected to an upper body of the operator 12. In this respect, the belt system 118 forms an upper body linking means device 120. By way of example and preference, the belt system 118 comprises multiple belts 122, which may preferably be made of textile. As shown in FIG. 10, the belt system 118 can be designed in such a way that the aid 10 can be worn like a backpack. In particular, the force introduction plate 116 may be displaceably connected to the belt system 118 such that a position of the force introduction plate 116 and thus a position of the upper body linking means 20 cranially 36 or caudally 104 may be changed.

As mentioned above, the upper body linking means comprises a first adjustment mechanism 112 which is configured to change a distance between first and second upper joint devices 106-1, 106-2 (indicated by the double arrows 124 in FIG. 9). For example, it is conceivable that the upper main body 108 has a rack and pinion mechanism similar to that of the lower main body 60 (cf. FIG. 6 and description above). In this respect, the first upper adjustment mechanism 112 can comprise a left and a right rack 77-1, 77-2, by means of which the supports 22-1, 22-2 are displaceably held on the main body 108 (cf. also FIG. 6).

In the example shown, the upper body linking means 20 also comprises a second upper adjustment mechanism 114, which is designed to change, in particular adjust, a position of the upper joint devices 106-1, 106-2 anteriorly (cf. arrow 72 in FIG. 9) or posteriorly (cf. arrow 74 in FIG. 9) relative to the frontal plane 52. An exemplary embodiment of the second upper adjustment mechanism 114 is only indicated schematically in FIG. 9. By way of example, the second upper adjustment mechanism 114 comprises three segments 126, 128, 130, wherein the first segment 126 is connected to the upper main body 108. By way of example, the first segment may be the rack 77-1, 77-2 of the first upper adjustment mechanism 112. The second segment 128 is connected to the upper joint device 106-1, 106-2. The third segment 130 is arranged between the first and second segments 126, 128 and is connected both to the first segment 126 and to the second segment 128 via a pivot connection 132. By way of example, the second upper adjustment mechanism 114 is designed such that the first segment 126 and the second segment 128 are always aligned parallel to each other.

FIG. 11 shows an exemplary embodiment of the upper body linking means 20, on the basis of which an embodiment of the optional upper joint devices 106-1, 106-2 is to be explained. In the example shown, the upper joint devices 106-1, 106-2 each comprise three degrees of articulation freedom. Specifically, the upper joint devices 106-1, 106-2 each comprise a first degree of freedom of pivoting (indicated by the arrow 134 in FIG. 11) about a first pivot axis 136. The upper joint devices 106-1, 106-2 also each comprise a second degree of freedom of pivoting (indicated by the arrow 138 in FIG. 11) about a second pivot axis 140 orthogonal to the first pivot axis 136. In addition, the upper joint devices 106-1, 106-2 each comprise a translational degree of freedom (indicated by the double arrow 142 in FIG. 11) along a longitudinal axis 54 of the support 22-1, 22-2. When the aid 10 is worn, the first pivot axis 136 is oriented in particular orthogonally to the median plane 50 and the second pivot axis 140 is oriented orthogonally to the frontal plane 52 (corresponding to the drawing plane in FIG. 11).

In the example shown, the first degree of freedom of pivoting is provided by a first pivot joint 144, which is connected to the upper main body 108 via the first and second upper adjustment mechanisms 112, 114 (not shown in detail in FIG. 11) (cf. also FIG. 9). The second degree of freedom of pivoting is provided by a second pivot joint 146, which is connected to the first pivot joint 144. The translational degree of freedom is provided by a displacement sleeve 148, which is connected to the second pivot joint 146 and in which the respective support 22-1, 22-2 is accommodated so as to be displaceable along the longitudinal axis 54. Preferably, the sliding sleeve 148 is designed such that the support 22-1, 22-2 is received in the sliding sleeve 148 such that it can pivot about its longitudinal axis 54. Preferably, the upper body linking means 20 is symmetrical in relation to the median plane 50.

An exemplary embodiment of an upper body linking means described above is shown in FIG. 12, wherein the same reference signs are used for identical or corresponding features. In the example shown, the upper joint devices 106-1, 106-2 each additionally comprise an optional third pivot joint 150 about a third pivot axis 152 orthogonal to the first and second pivot axes 136, 140.

A particularly advantageous effect of the aid 10 results from the interaction of the lower and upper body linking means 18, 20. As shown schematically in FIG. 13, the adjustability of the lower and upper body linking means 18, 20 in combination with the articulated connections of the supports 22-1, 22-2 with the lower and upper body linking means 18, 20 makes it possible to flexibly adapt the aid 10 to different body anatomies. For example, it is conceivable to simulate body anatomies with narrow hips and a broad back (cf. FIG. 13) and at the same time achieve a high degree of freedom of movement for the operator 12, e.g., to enable trunk flexion (cf. FIG. 5).

1. A wearable aid for supporting in the raising and/or holding of loads by an operator, comprising
a supporting structure having a first support and a second support, wherein the first support and the second support each have a rear section and a cantilever-type section, in such a way that, when the aid is worn by the operator, the back section is arranged posteriorly and extends substantially along the back section of the operator and the cantilever-type section extends posteriorly to anteriorly;
a lower body linking means for coupling the supporting structure to a pelvic, hip or lumbar area of the operator;
an upper body linking means for coupling the supporting structure to an upper body of the operator, in particular to a back, shoulder and/or chest region;
a first hand linking means for linking to a right hand or underarm region of the operator, wherein the first hand linking means is connected to the first support via a first length-adjustable connecting device;
a second hand linking means for linking to a left hand or underarm region of the operator, wherein the second hand linking means is connected to the second support via a second length-adjustable connecting device,
wherein the first support is connected to the lower body linking means at a first lower connection point via a first lower joint device, and wherein the second support is connected to the lower body linking means at a second lower connection point via a second lower joint device.

2. The wearable aid according to claim 1, wherein the first lower joint device and the second lower joint device each have at least two, in particular three, degrees of joint freedom.

3. The wearable aid according to claim 1, wherein the first lower joint device and the second lower joint device are each designed in such a way that, when the aid is worn, an angle of inclination of the support relative to the median plane and/or an angle of inclination of the support relative to the frontal plane can be changed, in particular adjusted, in particular independently of one another.

4. The wearable aid according to claim 1, wherein the first lower joint device and the second lower joint device are each designed in such a way that the support is pivotable, in particular rotatable, about its longitudinal axis.

5. The wearable aid according to claim 1, wherein the first support and the second support are each connected to the lower body linking means via a ball joint.

6. The wearable aid according to claim 1, wherein the lower body linking means is designed such that a relative position of the first lower connection point and the second lower connection point can be changed, in particular a position of the first lower connection point and/or of the second lower connection point can be changed, further in particular can be adjusted, in particular independently of one another, laterally and medially relative to the median plane and/or in the anterior direction and in the posterior direction relative to the frontal plane when the aid is worn.

7. The wearable aid according to claim 1, wherein the lower body linking means comprises a lower force distribution device connected to the supports, in particular via the lower joint devices, and wherein the lower body linking means comprises a flexible lower body linking means device connected to the lower force distribution device for linking to a body region of the operator, in particular wherein the lower body linking means device comprises at least one textile part, further in particular in the form of a belt, belt system or a cuff.

8. The wearable aid according to claim 6, wherein the lower force distribution device comprises a lower main body which extends between the first support and the second support and on which the lower joint devices are arranged.

9. The wearable aid according to claim 8, wherein the lower main body comprises a first lower adjustment mechanism which is designed to change, in particular to adjust, a distance between the lower connection points, further in particular to change the position of the lower connection points laterally and medially relative to the median plane.

10. The wearable aid according to claim 1, wherein the lower joint devices are each held on the lower body linking means, in particular on the lower main body, via a pivoting device, wherein the pivoting device is designed to change a position of the lower joint devices in the anterior direction or in the posterior direction relative to the frontal plane.

11. The wearable aid according to claim 6, wherein the lower force distribution device comprises a first hip shell for abutment against a right hip region of the operator and a second hip shell for abutment against a left hip region of the operator, wherein the first support is connected to the first hip shell via the first lower joint device, and wherein the second support is connected to the second hip shell via the second lower joint device, in particular, wherein the hip shells are designed such that, when the aid is worn, the hip shells project ventrally into a groin region of the operator such that dorsally directed forces can be introduced into the body of the operator via the hip shells.

12. The wearable aid according to claim 11, wherein the first and second hip shells are displaceably mounted on the lower body linking means device, in particular on the at least one textile part, in particular such that by displacing the first and/or the second hip shell relative to the lower body linking means device, a distance between the lower connection points relative to one another, in particular a position of the lower connection points laterally and medially relative to the median plane and/or in the anterior direction and in the posterior direction relative to the frontal plane, can be varied, in particular adjusted.

13. The wearable aid according to claim 11, wherein the lower force distribution device additionally comprises at least one lumbar support which is force-coupled to the first and/or the second hip shell via the lower body linking means device, in particular wherein the at least one lumbar support is supported on the lower body linking means device, in particular on the at least one textile part, so as to be displaceable cranially and/or caudally.

14. The wearable aid according to claim 1, wherein the first support is connected to the upper body linking means at a first upper connection point, in particular in an articulated manner, further in particular via a first upper joint device, and wherein the second support is connected to the upper body linking means at a second upper connection point, in particular in an articulated manner, further in particular via a second upper joint device.

15. The wearable aid according to claim 14, wherein the first upper joint device and the second upper joint device each have at least three degrees of joint freedom.

16. The wearable aid according to claim 14, wherein the first upper joint device and the second upper joint device each comprise:
a. a first degree of freedom of pivoting about a first pivot axis which is orthogonal to the median plane, in particular when the aid is worn;
b. a second degree of freedom of pivoting about a second pivot axis orthogonal to the first pivot axis, in particular orthogonal to the frontal plane when the aid is worn;
c. a translational degree of freedom along a longitudinal axis of the support, in particular along a longitudinal axis of the back section of the support.

17. The wearable aid according to claim 16, wherein the first degree of freedom of pivoting is provided by a first pivot joint connected to the upper body linking means, and wherein the second degree of freedom of pivoting is provided by a second pivot joint connected to the first pivot joint.

18. The wearable aid according to claim 16, wherein the translational degree of freedom is provided by a displacement sleeve in which the support is axially displaceably received, in particular wherein the displacement sleeve is designed such that the support is pivotable about its longitudinal axis.

19. The wearable aid according to claim 1, wherein the upper body linking means comprises an upper force distribution device connected to the supports, in particular via the upper joint devices, and wherein the upper body linking means comprises a flexible upper body linking means device connected to the upper force distribution device for linking to an upper body region of the operator, in particular wherein the upper body linking means device comprises at least one textile part, further in particular in the form of a belt, belt system or a cuff.

20. The wearable aid according to claim 19, wherein the upper force distribution device comprises an upper main body which extends between the first support and the second support, in particular on which the upper joint devices are arranged.

21. The wearable aid according to claim 19, wherein the upper force distribution device comprises a force introduction plate, which is connected to the upper body linking means device on the one hand and to the upper main body on the other hand in such a way that a distance of the force introduction plate to the upper main body and/or a position of the force introduction plate can be changed, in particular can be adjusted, cranially and caudally.

22. The wearable aid according to claim 14, wherein the upper body linking means is designed such that a relative position of the first upper connection point and the second upper connection point can be changed, in particular a position of the first upper connection point and/or of the second upper connection point can be changed, in particular adjusted, laterally and medially relative to the median plane and/or in the anterior direction and in the posterior direction relative to the frontal plane, in particular independently of one another, when the aid is worn.

23. The wearable aid according to claim 14, wherein the upper and the lower body linking means are designed in such a way that a relative position of the upper connection points and a relative position of the lower connection points can be changed, in particular can be adjusted, independently of one another.

24. The wearable aid according to claim 14, wherein the first and the second support are each assigned a first upper adjustment mechanism, which is designed to displace the upper connection point laterally and medially when the aid is worn and/or
wherein the first and the second support are each assigned a second upper adjustment mechanism, which is designed to displace the upper connection point in the anterior direction and in the posterior direction when the aid is worn.

25. The wearable aid according to claim 24, wherein the second upper adjustment mechanism comprises three mutually adjustable segments,
wherein a first segment is connected to the upper main body, wherein a second segment is connected to the support, in particular via the upper joint device,
wherein a third segment is arranged between the first segment and the second segment and is pivotably connected to the first segment and pivotably connected to the second segment, in particular in such a way that the first segment and the second segment are aligned parallel to one another.

26. The wearable aid according to claim 1, wherein a fixing device for fixing a relative position of the first and second lower connection points and/or a fixing device for fixing a relative position of the first and second upper connection points is provided.

27. The wearable aid according to claim 1, wherein a fixing device for fixing the first and second lower joint devices and/or a fixing device for fixing the first and second upper joint devices is provided.

28. The wearable aid according to claim 1, wherein the cantilever-type section is pivotably connected to the respective back section, in particular about a first cantilever pivot axis parallel to the longitudinal axis of the back section and/or about a second cantilever pivot axis orthogonal to the longitudinal axis of the back section and to a longitudinal axis of the cantilever-type section.
